(19) United States
(12) Patent Application Publication
(10) Pub. No.: US 2012/0278147 A1
(43) Pub. Date: Nov. 1, 2012

(54) Method and Apparatus for Online Marketing

(75) Inventors: Ruslan Kogan, Melbourne (AU); Goran Stefkovski, Hampton (AU); Jesse Xavier O'Connor, Travancore (AU)

(73) Assignee: Kogan Technologies Pty Ltd, Hampton (AU)

(21) Appl. No.: 13/409,093

(22) Filed: Feb. 29, 2012

(30) Foreign Application Priority Data
Apr. 29, 2011 (AU) 2011901570

(51) Int. Cl. G06Q 30/02

(52) U.S. Cl. 705/14.16

(57) ABSTRACT

An apparatus and for distributing a communication within a computer network using social media and expanding a business's email or distribution contact list in a self-perpetuating self-expanding manner. The apparatus comprising a processor element adapted to: present a user interface to a first prospective client for receiving registration data; present a user interface to a first client for receiving data indicative of contact details of one or more second prospective clients; generate a respective second communication for distributing to each of one or more second prospective clients; and award an client benefit to the first client for each of the one or more second prospective clients associated with a corresponding unique registration.

### FIELD OF THE INVENTION

The present invention relates to advertising and in particular to advertising for electronic media.

The invention has been developed primarily for use as a method and apparatus for expanding business contact lists through distributing advertising in a self-expanding (viral) manner and will be described hereinafter with reference to this application. However, it will be appreciated that the invention is not limited to this particular field of use.

### BACKGROUND OF THE INVENTION

Any discussion of the prior art throughout the specification should in no way be considered as an admission that such prior art is widely known or forms part of the common general knowledge in the field.

There is a need in the art for a self-expanding means of business database growth.

### OBJECT OF THE INVENTION

It is an object of the present invention to overcome or ameliorate at least one of the disadvantages of the prior art, or to provide a useful alternative.

It is an object of the invention in a preferred form to provide a method and apparatus for expanding a business's database of contacts through a self-perpetuating self-expanding medium.

### SUMMARY OF THE INVENTION

According to an aspect of the invention there is provided a method for expanding a business's email or distribution contact list in a self-perpetuating self-expanding manner through distributing communications (for example advertising), the method comprising the steps of:
distributing a first communication being accessible by a first prospective client, the communication being further associated with a client (or member) benefit;
receiving, from the first prospective client, data indicative of registration for the client benefit;
generating a respective second communication for distributing to each of the one or more second prospective clients;
awarding a client benefit to the first prospective client for each of the one or more second prospective clients associated with a corresponding unique registration for the client benefit.

Preferably, the first communication is indicative of an advertisement being accessible by a first prospective client. More preferably, the advertising is further associated with a client benefit.

Preferably, the method includes the steps of:
receiving, in association with the first prospective client, data indicative of contact details of one or more second prospective clients;
wherein a respective second communication is generated for distributing to each of the one or more second prospective clients using the contact details received.

Preferably, the client benefit can include an entry into a competition entry (associated with a competition), reward points, or a store credit.

Preferably, the first prospective client provides registration data for receiving the client benefit. The first prospective client is preferably registered for the client benefit in response to the first communication. More preferably, the first prospective client accesses a control user interface for registering (or logging to an existing client account or member account). Most preferably, the first prospective client accesses a control user interface for enabling receipt of data indicative of contact details of one or more second prospective clients.

Preferably, the first prospective client provides registration data for receiving the client benefit (for example entry to a competition). More preferably, registration data is retained for extending a client contact database. Most preferably the first prospective client is unique to the client contact database.

Preferably, the method comprises the step of: presenting a control user interface to the first prospective client. The control user interface preferably being accessible by the first prospective client to enable any one or more of the steps selected from the set comprising:
receiving, from the first prospective client, data indicative of registration for the client benefit;
receiving, in association with the first prospective client, data indicative of contact details of one or more second prospective clients;
presenting a provisional counter indicating a count of second prospective clients that have been distributed a respective second communication, but that have not yet registered;
presenting a confirmed counter indicating a count of second prospective client that have a corresponding registration to the client benefit; and
presenting a client selectable sequence of electronic data entry forms, each operatively associated with receiving data indicative of contact details of one or more second prospective clients from a digital media.

Preferably, a client has a corresponding unique registration.

Preferably, each registered second prospective client provides registration data for entry to the client benefit. More preferably, registration data is retained for extending a client contact database. Most preferably each registered second prospective client is unique to the client contact database. The confirmed counter preferably only indicating a count of unique second prospective clients that have registered in response to the respective second communication.

Preferably, each communication indicative of an advertisement has a tracking element. More preferably, the tracking element enables the method to identify the first prospective client associated with the second communication. Most preferably, the method receives the tracking element for attributing registration of second prospective clients to a respective first prospective client.

Preferably, each communication indicative of an advertisement has a tracking element. The tracking element is preferably embedded in a web link used to access the advertisement and/or client benefit and/or competition.

Preferably, the first prospective client is awarded a client benefit (for example an entry in the competition) by responding to the advertisement. More preferably, the first prospective client is awarded an additional client benefit (for example entry in the competition) by introducing a second prospective client responding to the advertisement. Most preferably, the first prospective client is awarded an additional client benefit (for example entry in the competition) upon registration of an introduced unique second prospective client that responds to the advertisement.

Preferably, the advertisement is made accessible by the first prospective client via a digital media. More preferably, the advertisement is made accessible by any one or more digital media selected from a set comprising: a web link associate with a web page comprising the advertisement; a wall post or private communication made via an online social network; an online email provider; a private email; a mobile message; or a SMS. Most preferably, receiving data indicative of contact details includes any one or more selected from the set comprising: receiving data indicative of a social network friends list; receiving data indicative of an online email provider contact list; receiving data indicative of a private email provider contact list.

Preferably, the second communication is communicated directly to the second prospective client. Alternatively, the second communication is preferably published online for access by the second prospective client. The second communication can preferably be published online for access by the second prospective client using a social media, for example “Twitter”.

According to an aspect of the invention there is provided an apparatus for disseminating communication (for example advertising) using social media, the apparatus comprising:
a processor element coupleable to a client contact database, the database being adapted to retain a data record for each registered client;
the processor element being adapted to:
present a user interface to a first prospective client for receiving registration data;
present a user interface to a first client for receiving data indicative of contact details of one or more second prospective clients;
generate a respective second communication for distributing to each of one or more second prospective clients; and
award an client benefit to the first client for each of the one or more second prospective clients associated with a corresponding unique registration.

Preferably the processor element is adapted to present a user interface to a first client for receiving data indicative of contact details of one or more second prospective clients; and generating a respective second communication for distributing to each of one or more second prospective clients using the contact details received.

Preferably, the processor module is further adapted to record particulars of the entry such as the time between invitation and confirmation, the source of the confirmation.

Preferably, the processor module is further coupleable to a data network for presenting the user interface. More preferably, the processor module is further coupleable to a data network for communicating with a digital media. Most preferably, the digital media enables receipt of data indicative of contact details of one or more second prospective clients.

Preferably, the processor module is coupleable to one or more remote digital media systems for receiving a contact list (or friends list). More preferably, data indicative of contact details of one or more second prospective clients is received from the remote digital media systems. Most preferably, the data indicative of contact details are received upon the first client providing access authentication for the respective digital media system.

According to an aspect of the invention there is provided an apparatus for communicating using social media, the apparatus comprising a processor element adapted to perform a method as herein disclosed.

According to an aspect of the invention there is provided a user access interface for a processor device, the processor device being coupleable to database adapted to retain a data record for each registered client; the interface comprising: a control program adapted to perform a method as herein disclosed.

According to a further aspect of the invention there is provided a computer program product stored on a computer usable medium, the computer program product adapted to provide a method as herein described.

According to a further aspect of the invention there is provided a computer readable medium for operation with a processor device, the computer readable medium comprising computer code for executing a method as herein described.

### BRIEF DESCRIPTION OF THE DRAWINGS

A preferred embodiment of the invention will now be described, by way of example only, with reference to the accompanying drawings in which:

FIG. 1A is a schematic view of an apparatus according to the invention;

FIG. 1B is a schematic view of an apparatus according to the invention;

FIG. 2A is a schematic flowchart of a method according to the invention;

FIG. 2B is a schematic flowchart of a method according to the invention;

FIG. 3A is a schematic view of a user interface according to the invention, showing initiating entry to a competition;

FIG. 3B is a schematic view of a user interface according to the invention, showing a sign-on access;

FIG. 3C is a schematic view of a user interface according to the invention, showing a login access;

FIG. 4 is a schematic view of a user interface according to the invention, showing a control access; and

FIG. 5 is a schematic view of a user interface according to the invention, showing a wizard interface.

### PREFERRED EMBODIMENT OF THE INVENTION

In an embodiment apparatus for expanding a business's database of contacts through a self-perpetuating self-expanding medium, an incentive can be provided to each entrant to invite further entrants into the competition (or other incentive scheme) and the facilitation of these invitations through an easy-to-use wizard or engine. It will be appreciated that a competition is only one preferred embodiment. The apparatus and method can be used to reward existing customers for advertising or promoting a business to their contacts and on their public forums such as ‘Facebook’. For instance, a reward could be that a customer receives a store credit for each customer who buys a product at a business or joins an email distribution list as a result of being introduced by an existing customer (through email or Facebook links, etc).

It will be appreciated that in an embodiment, an incentive is presented to each prospective client to invite his or her contacts, and to thereby provide a means of infinitely expanding the potential client pool (for example in a “viral” manner). It is typically a condition of receiving a client benefit (for example entry into the competition) that the client agrees to receive marketing communications (for example emails) from the promoter.

In an embodiment, a prospective client can be sent communication indicative of an advertisement, wherein the advertising is associated with a client benefit or member benefit. It will be appreciated that the advertisement can be merely an advertisement (or a representation) of a company offering the client/member benefit or conducting the competition. Typically, a condition of entry is that the entrant has to agree to receive email communications and other marketing messages—thereby expanding a business's email database.

By way of example, each registered client is awarded an entry in the competition for each prospective client they invite, and who accepts registration. A data record for each registered client/entrant is stored in a client contact database. A registered client can invite their “friends” as prospective clients through digital media (for example via a digital media system) including: Facebook, Twitter, GMail, Hotmail, Yahoo, and other social or email providers. A registered client can also invite a prospective client by manually providing a contact detail, such as an email address.

It will be appreciated that this competition enables a client contact (or subscriber) database to be extended, by encouraging registered clients to invite their friends as prospective clients—who then invite their friends and so on. Terms and Conditions associated with the competition require that each entrant agrees to join the subscriber database.

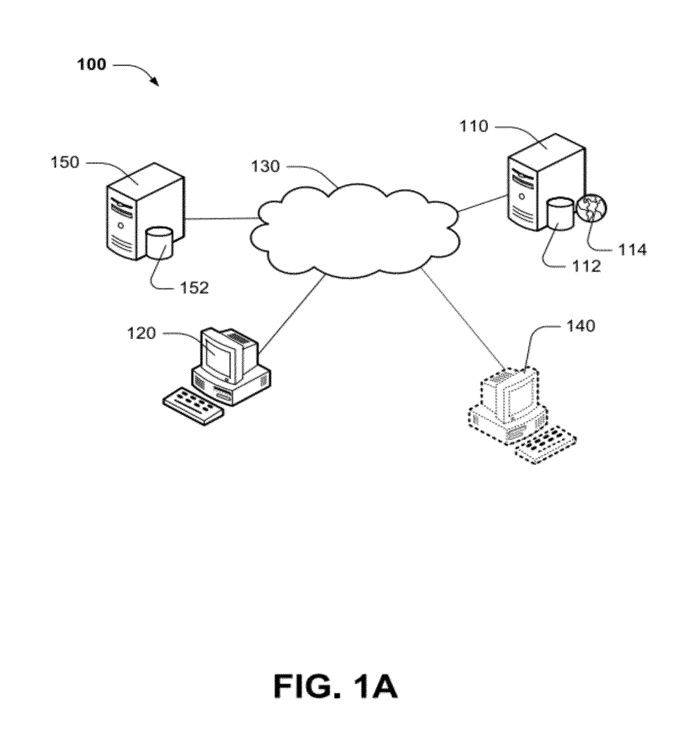

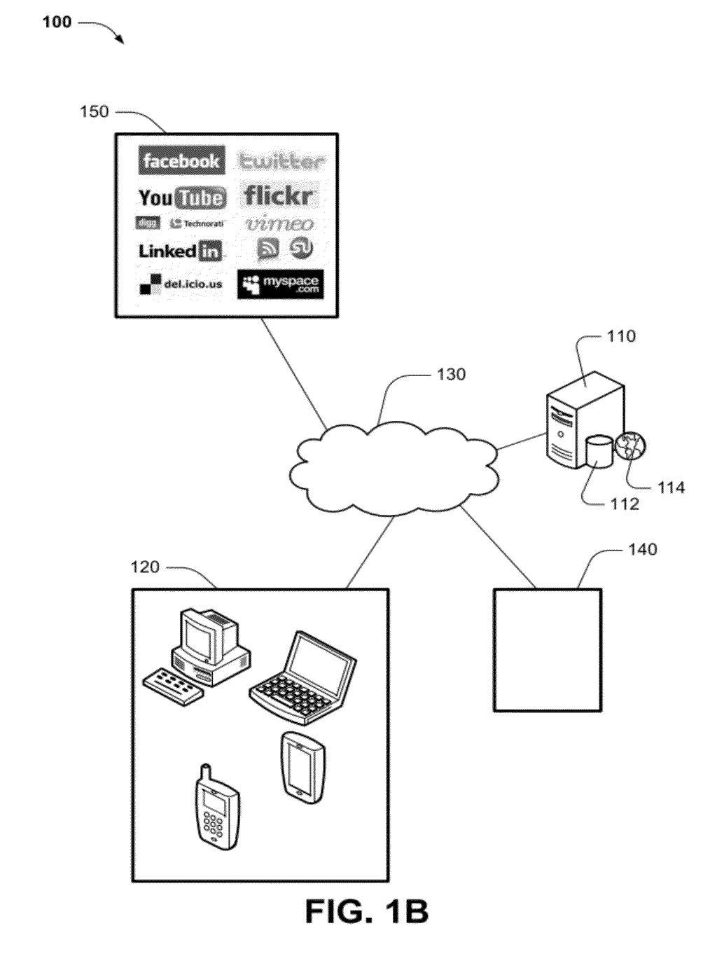

FIG. 1A and FIG. 1B show an embodiment apparatus 100 for advertising using social media. This apparatus comprises a processor element 110 coupleable to a client contact database 112 adapted to retain a data record for each registered client.

The processor element 110 includes a web server 114 adapted to present a user interface to a first prospective client 120 for receiving registration data via a data network 130. The user interface (for example a web interface) enables data indicative of contact details of one or more second prospective clients 140 to be provided (by the first prospective client) and received.

A second communication is generated for distributing to each of the one or more second prospective clients 104 using the contact details received. An entry is awarded (or allocated) to the first client for each of the one or more second prospective clients associated with a corresponding unique registration to the competition.

In an embodiment, the processor module 100 is coupleable to a data network 130 for presenting the user interface and for communicating with one or more digital media servers 150. The first client can authorise via the user interface that a digital media server to deliver or enable receipt of data indicative of contact details of one or more second prospective clients. The processor module is coupleable to one or more remote digital media systems—including Facebook, Twitter, GMail, Hotmail, Yahoo, and other social or email providers—for receiving a contact list or friends list. Access to a digital media system or social media environment can be authorised by the first client, wherein the processor module accesses a contact list via an application interface presented by the digital media system or social media environment.

It will be appreciated that the second communication includes a tracking element, typically encoded in a URL, enables the respective first client to be identified, and credited with introducing a new prospective client. The tracking element also enables recording the source through which the new prospective client has been introduced. The tracing element is typically encoded into a generated URL and included in the respective second communication distributed to each of the one or more second prospective clients, for accessing/registering with the client database and/or associated competition.

It will be appreciated that existing contacts are not strictly necessary, as a unique referral link is generated (second communicant) that can be advertised in any public forum, whereby each new registrant using the link is associated with the initial client that posted the link.

It would be appreciated that distributing the second communication can include: sending the second communication via an email; sending the second communication via a private message enabled by a social media email; posting the second communication to a common area in a social media environment that is viewable by each of the second clients. The first client can repeatedly/iteratively provide data indicative of contact details of one or more second prospective clients for receipt by the processor module 100, typically each iteration corresponding to a separate method of providing data or a different social media environment.

In an embodiment, measures to prevent fraudulent registration for client benefits or entries into the competition—typically through identification of registration through false or manufactured contact details (for example email addresses).

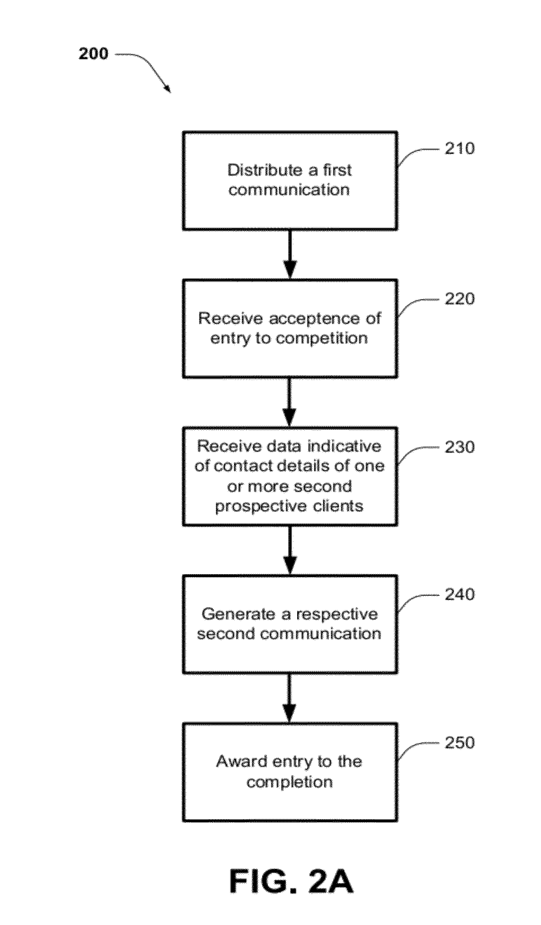

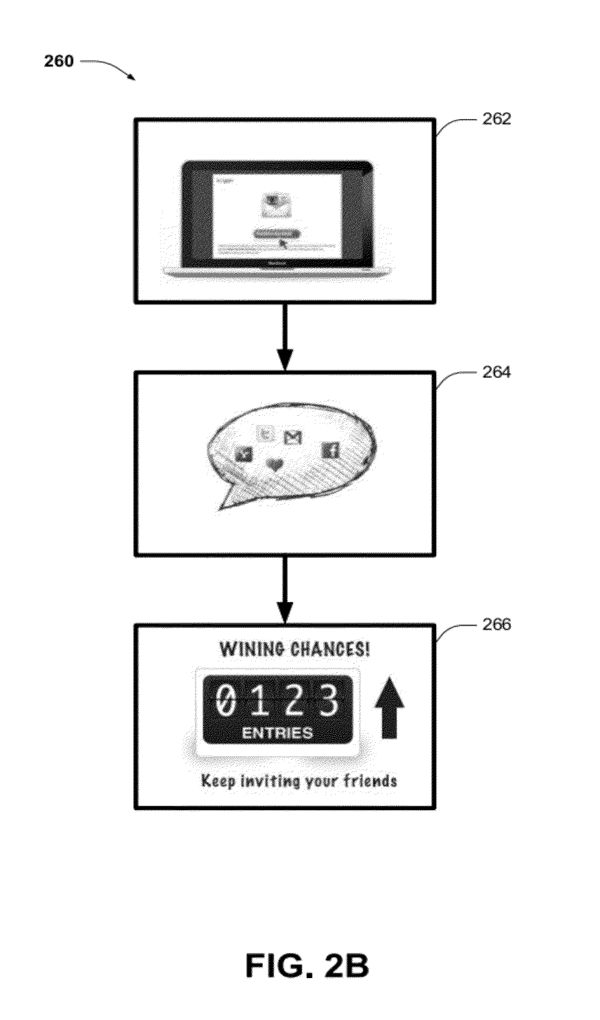

FIG. 2A shows a flowchart of an embodiment method 200 for distributing an advertising communication. This method comprises the steps of:
STEP 210: distributing a first communication indicative of an advertisement being accessible by a first prospective client, the advertising being further associated with a client benefit (for example a competition);
STEP 220: receiving, from the first prospective client, data indicative of registration for the client benefit (or accepting entry to the competition);
STEP 240: generating a respective second communication for distributing to each of one or more second prospective clients;
STEP 250: awarding an entry to the first prospective client for each of the one or more second prospective clients associated with a corresponding unique registration to the client benefit.

The client benefit can include an entry into a competition, reward points, or store credit.

The first communication can include a posted advertisement to enter the competition on public forums (such as Facebook or a blog) or an electronic message (such as SMS or email).

This method can further comprise the steps of:
STEP 230: receiving, in association with the first prospective client, data indicative of contact details of one or more second prospective clients;
STEP 240: generating a respective second communication for distributing to each of the one or more second prospective clients using the contact details received.

It is noted that contact details are not always necessary. It is an embodiment, an entrant can be awarded a further entry for each person who registers for the client benefit (for example joins a competition) as a result of clicking a unique link attributed to the first client could be posted on Facebook, other public forums, or otherwise spread without the use of existing contact lists. However, it would be appreciated that, existing contact lists are also beneficial in enabling distribution of advertising communications.

It is typically a condition of registration (or entry into the competition) that the client agrees to receive email or other marketing messages from the business.

It will be appreciated that reporting functionality can enable a business to see the precise manner in which a client has registered for the client benefit (entrant into the competition), providing the host information as to the social ‘influence’ of a client (e.g. via the pyramid tree and the breakdown of the success of each external share method). Preferably, particulars of the entry—such as the time between invitation and confirmation, and the source of the confirmation—are recorded. This can also enable identification of the source of second communication (e.g. the second client entered via Twitter or Facebook)

Referring to FIG. 2B, a method 260 for distributing advertising communication can be summarised as comprising the steps of:
STEP 262: distributing a first communication indicative of an advertisement being accessible by a first prospective client, the advertising being further associated with a client benefit (for example a competition entry);
STEP 264: receiving, in association with the first prospective client, data indicative of contact details of one or more second prospective clients, wherein the data received is with respect to any one or more of:
   authorised access to a social media contact list,
   authorised access to a email contact list from a remote email provider,
   authorised access to a email contact list from a local email account;
   authorised access to a “common area” in a social media environment that is viewable by each of the second clients, and
   a manually entered list of contact details; and
   wherein a second communication is distributed to each of the one or more second prospective clients using the contact details received;
STEP 266: awarding an entry to the first prospective client for each of the one or more second prospective clients associated with a corresponding unique registration to the client benefit.

The method can comprise the step of: presenting a control user interface to the first prospective client. The control user interface being accessible by the first prospective client to enable the steps of:
presenting a provisional counter indicating a count of second prospective clients that have been distributed a respective second communication, but that have not yet registered; and
presenting a confirmed counter indicating a count of second prospective client that have a corresponding registration to the client benefit.

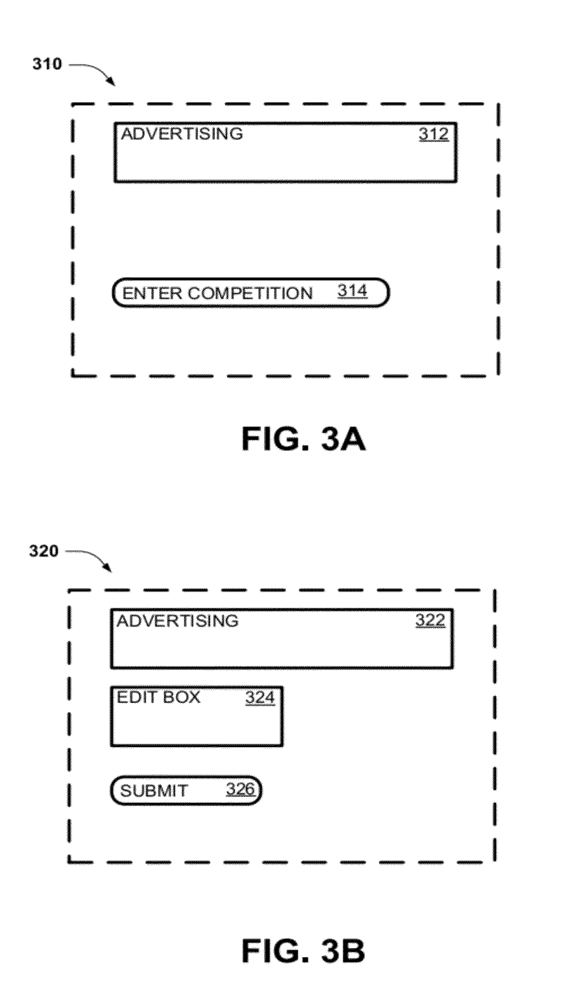

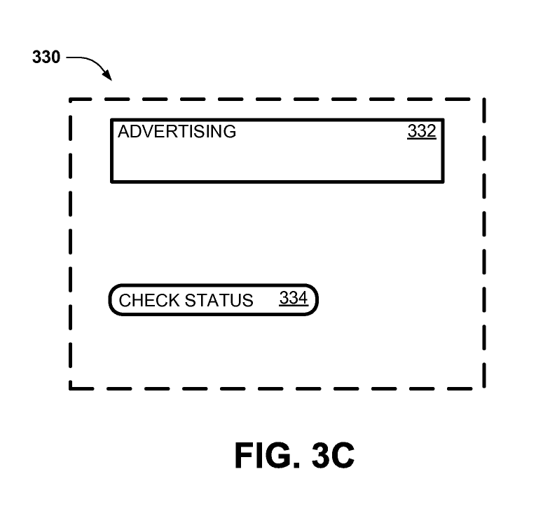

FIG. 3A shows a user interface 310 for directing a first prospective client to register for a client benefit in the form of a entry to a competition. In this user interface, the first prospective client is presented advertising 312. A web link 314 can also be presented for directing the first client to an interface for providing their contact details for registering in the competition. This user interface is typically presented via an email of web interface upon registration to the competition. The first prospective client is typically presented this interface upon request of an existing client, or upon registration with a previous competition.

FIG. 3B shows a user interface 320 for directing a first prospective client to provide respective contact details for entering a competition. In this user interface, the first prospective client is presented advertising 322. An edit box 324 is presented for the first client to provide their contact details for registering in the competition, which is submitted by actioning a submit button 326. This user interface is typically in the form of a web interface.

FIG. 3C shows a user interface 330 for directing a first prospective client to check the status of their client account. In this user interface, the first prospective client is presented advertising 332. A web link 334 can also be presented for directing the first client to a web interface for checking the status of their client account. This user interface is typically presented via an email of web interface upon registration to the competition.

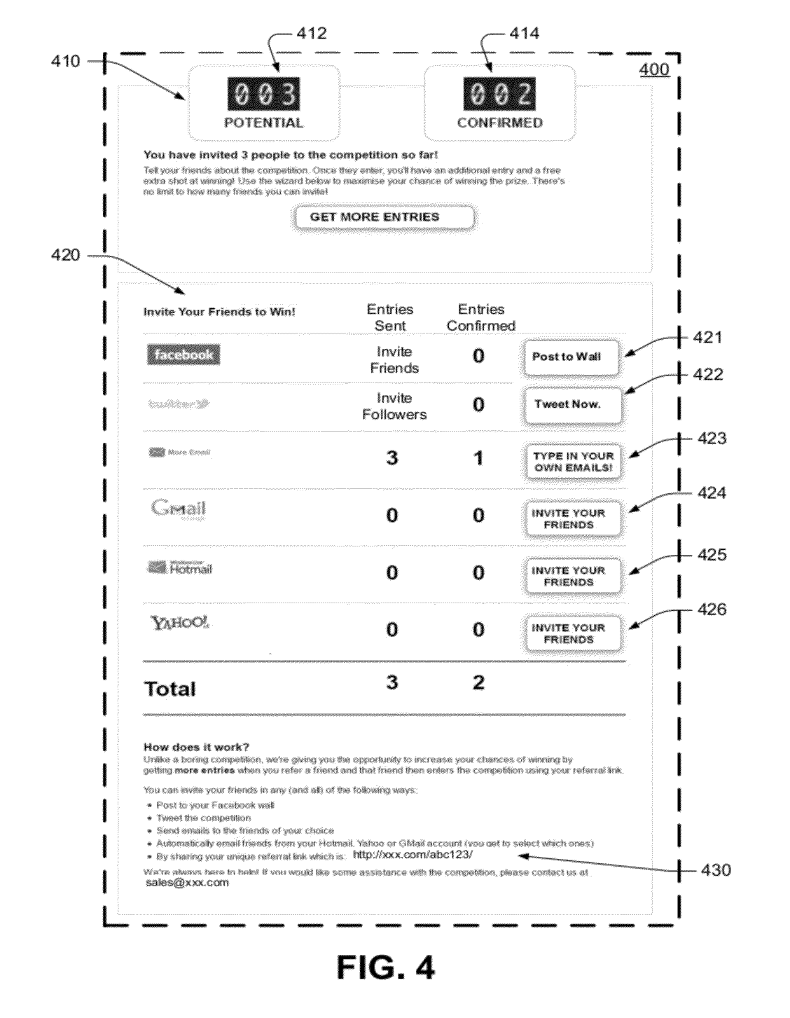

FIG. 4 is a schematic view of a user interface 400 according to the invention, showing a control access for enabling a first client to check the status of their client account and/or invite one or more second prospective clients. The first client having a corresponding unique registration to the competition.

The user interface 400 includes one or more status counter 410. In this embodiment, a first status counter 412 indicates the number of provisional entries into the competition, for example being the number of second prospective clients introduced by the first client that have not yet registered. In this embodiment, a second status counter 414 indicates the number of entries into the competition, for example being the number of second prospective clients introduced by the first client that have registered.

The confirmed counter typically only indicates a count of unique second prospective client that have registered in response to a respective invitation communication.

The user interface 400 includes one or more modules 420 for enabling the first client to invite one or more second prospective clients. In this embodiment, the modules enable the user to:
at 421, grant access to at least a subset of contacts on Facebook;
at 422, to post to Twitter on behalf of the first prospective client, thereby obtaining access to respective followers;
at 423, to manually provide contact details (for example email addresses) for one or more second prospective clients;
at 424, grant access to at least a subset of contacts on the first clients Gmail account;
at 425, grant access to at least a subset of contacts on the first clients Hotmail account;
at 426, grant access to at least a subset of contacts on the first clients Yahoo account;

The user interface 400 also presents a unique referral web link 430, which the first client can distribute to one or more second prospective clients. Second prospective clients using the referral link to enter the competition can be attributed to the first client.

A user interface wizard can guide a client through the available distribution channels.

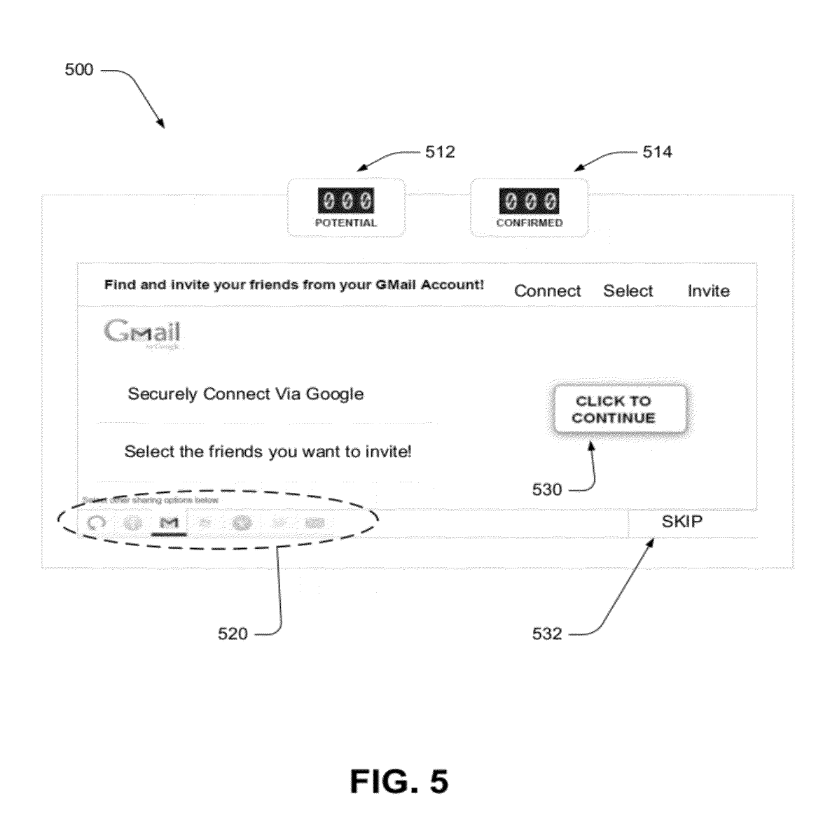

Referring to FIG. 5, an embodiment user interface wizard 500 sequences through each of the available distribution channels. To incentivise a client, this embodiment presents a first status counter 512 that indicates the number of provisional benefits/entries, and a second status counter 514 that indicates the number of benefits/entries awarded.

In this example, tabs 520 indicate the available distribution channels, including Facebook, Gmail, Hotmail, Yahoo, Twitter, and email invitations. The client can select to proceed with using the present distribution channels 530 or skip the step 540.

In addressing the wizard, by way of example, the wizard prompts the client as follows:
Facebook: Click on the ‘Post to your Wall’ Button to Post to your Facebook Wall. You gain an entry for each person that clicks on your post and registers.
Gmail: Securely Connect via Google, all we do is retrieve a list of contacts for you—we do not store your password. Select the friends you want to invite! Each friend that accepts your invite will give you an extra entry.
Hotmail: Securely connect via Windows Live Mail, all we do is retrieve a list of contacts for you—we do not see your password. Select the friends you want to invite! Each friend that accepts your invite will give you an extra entry.
Yahoo: Securely connect via Yahoo Mail, all we do is retrieve a list of contacts for you—we do not see your password. Select the friends you want to invite! Each friend that accepts your invite will give you an extra entry.
Twitter: Share this competition on Twitter! The Twitter share box pops up, follow the prompts and then you're back!
Email: Provide a list of email addresses and respective contact names.

It will be appreciated that the apparatus is not limited to awarding competition entries. An apparatus can award a client/member benefit selected from any one or more of the set including (but not limited to): competition entries, ‘credits’, ‘gift voucher’, money, and reward point. Typically, client benefits (or member benefits) are awarded in accordance with the number of new clients invited to join the program/competition.

In an embodiment, the first prospective client—in response to the first communication—provides registration data for entry to the competition. The first prospective client accesses a control user interface for enabling receipt of data indicative of contact details of one or more second prospective clients.

Registration data is typically retained for extending a client contact database, comprising unique prospective clients. Each registered second prospective client provides registration data for entry to the competition, wherein registration data is retained for extending a client contact database.

Each communication indicative of an advertisement typically has a tracking element that enables identification of the first prospective client associated with initiating the invitations.

The tracking element can be retrieved (or accessed) for attributing registration of second prospective clients to a respective first prospective client.

It will be appreciated that a tracking element can be embedded in a web link used to access the advertisement and/or competition.

In an embodiment, the first prospective client is awarded an entry in the competition by responding to the advertisement. Additional entries in the competition can be awarded for introducing second prospective clients that are introduced and respond to the invitation (or advertisement). Typically, the first prospective client is awarded an additional entry in the competition upon registration of each introduced unique second client that responds.

The competition/invitation/advertisement is made accessible by the first prospective client via a digital media selected from a set comprising: a web link associated with a web page comprising the advertisement; a wall post or private communication made via an online social network; an online email provider; or a private email.

It will be appreciated that, receiving data indicative of contact details can include any one or more selected from the set comprising: receiving data indicative of a social network friends list; receiving data indicative of an online email provider contact list; receiving data indicative of a private email provider contact list.

In an embodiment, a second communication is communicated directly (for example using email or private messaging) to the second prospective client or published online (for example using Twitter or Facebook wall) for access by the second prospective client.

It will be appreciated that an illustrated method and apparatus can provide advantages, including any one or more of the following:
providing a self-expanding self-perpetuating means of growing of a client email list or customer base, through an incentive program and the mechanism (or engine) to carry this out;
incentivising each existing entrant or customer to market a business to their contacts or on public forums available to them—typically through awarding client/member benefits, client benefits including entries to a competition, store credit incentive schemes, extension of warranty periods, or any other reward available to a promoter;
growing of a client email list or customer base by each new registered client agreeing to be part of the email database of the promoter business;
presenting a wizard engine which guides each entrant through a sequence of processes for gaining more benefits/incentives (or entries) by advertising the competition or scheme publicly or contacting existing relationships;
fraudulent entries or manufactured email addresses can be identified and eliminated.

It will be appreciated that the illustrated method and apparatus can distribute advertising using established contact lists.

It would be appreciated that, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment.

Thus, one embodiment of each of the methods described herein is in the form of a computer-readable carrier medium carrying a set of instructions, e.g., a computer program that are for execution on one or more processors.

Unless specifically stated otherwise, as apparent from the following discussions, it is appreciated that throughout the specification discussions utilizing terms such as “processing”, “computing”, “calculating”, “determining” or the like, can refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken is included.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Similarly, it is to be noticed that the term “coupled”, when used in the claims, should not be interpreted as being limitative to direct connections only. The terms “coupled” and “connected”, along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Reference throughout this specification to “one embodiment” or “an embodiment” means that a particular feature, structure or characteristic described in connection with the embodiment is included in at least one embodiment. Thus, appearances of the phrases “in one embodiment” or “in an embodiment” in various places throughout this specification are not necessarily all referring to the same embodiment, but may refer to the same embodiment. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description. Although the invention has been described with reference to specific examples, it will be appreciated by those skilled in the art that the invention may be embodied in many other forms.

It will be appreciated that an embodiment of the invention can consist essentially of features disclosed herein. Alternatively, an embodiment of the invention can consist of features disclosed herein. The invention illustratively disclosed herein suitably may be practiced in the absence of any element which is not specifically disclosed herein.

The claims defining the invention are as follows:

1. A method of communication distribution within a computer network for expanding a distribution contact list in a self-perpetuating self-expanding manner through distributing communications, the method comprising the steps of:
(a) distributing a first communication being accessible by a first prospective client, the communication being further associated with a client benefit;
(b) receiving, from the first prospective client, data indicative of registration for the client benefit;
(c) generating a respective second communication for distributing to each of the one or more second prospective clients;
(d) awarding a client benefit to the first prospective client for each of the one or more second prospective clients associated with a corresponding unique registration for the client benefit.

2. The method according to claim 1, wherein the distributing communications is an advertising communication.

3. The method according to claim 1, wherein the first communication is indicative of an advertisement being accessible by a first prospective client.

4. The method according to claim 3, wherein, the method includes the steps of:
(i) receiving, in association with the first prospective client, data indicative of contact details of one or more second prospective clients;
(ii) wherein a respective second communication is generated for distributing to each of the one or more second prospective clients using the contact details received.

5. The method according to claim 4, wherein the advertisement is further includes a client benefit.

6. The method according to claim 5, wherein the client benefit can include an entry into a competition entry associated with a competition, reward points, or a store credit.

7. The method according to claim 5, wherein the first prospective client provides registration data for receiving the client benefit in response to the first communication.

8. The method according to claim 7, wherein the first prospective client accesses a control user interface for accessing a client account, and provides data indicative of contact details of one or more second prospective clients.

9. The method according to claim 8, wherein each client has a corresponding unique registration.

10. The method according to claim 9, wherein the method comprises the step of: presenting a control user interface to the first prospective client, the control user interface being accessible by the first prospective client to enable any one or more of the steps selected from the set comprising:
receiving, from the first prospective client, data indicative of registration for the client benefit;
receiving, in association with the first prospective client, data indicative of contact details of one or more second prospective clients;
presenting a provisional counter indicating a count of second prospective clients that have been distributed a respective second communication, but that have not yet registered;
presenting a confirmed counter indicating a count of second prospective client that have a corresponding registration to the client benefit; and
presenting a client selectable sequence of electronic data entry forms, each operatively associated with receiving data indicative of contact details of one or more second prospective clients from a digital media.

11. The method according to claim 10, wherein the first prospective client provides registration data for receiving the client benefit in the form of entry to a competition, and registration data is retained for extending a client contact database.

12. The method according to claim 11, wherein each registered second prospective client provides registration data for entry to the client benefit; and registration data is retained for extending a client contact database; and the confirmed counter only indicating a count of unique second prospective clients that have registered in response to the respective second communication.

13. The method according to claim 12, wherein each communication indicative of an advertisement has a tracking element; and the tracking element enables identification of the first prospective client associated with the second communication such that the tracking element can be received for attributing registration of second prospective clients to a respective first prospective client.

14. The method according to claim 11, wherein the first prospective client is awarded a client benefit by responding to the communication indicative of an advertisement; and the first prospective client is awarded an additional client benefit for introducing each second prospective client that responds to the advertisement.

15. The method according to claim 14, wherein and the first prospective client is awarded an additional client benefit upon registration of an introduced unique second prospective client that responds to the advertisement the communication indicative of an advertisement.

16. The method according to claim 15, wherein the second communication is published online for access by the second prospective client.

17. An apparatus for distributing a communication within a computer network using social media and expanding a distribution contact list in a self-perpetuating self-expanding manner, the apparatus comprising:
a processor element coupleable to a client contact database, the database being adapted to retain a data record for each registered client;
the processor element being adapted to:
present a user interface to a first prospective client for receiving registration data;
present a user interface to a first client for receiving data indicative of contact details of one or more second prospective clients;
generate a respective second communication for distributing to each of one or more second prospective clients; and
award an client benefit to the first client for each of the one or more second prospective clients associated with a corresponding unique registration.

18. The apparatus according to claim 17, wherein the processor element is adapted to present a user interface to a first client for receiving data indicative of contact details of one or more second prospective clients; and generating a respective second communication for distributing to each of one or more second prospective clients using the contact details received.

19. The apparatus according to claim 18, wherein, the processor element is coupleable to one or more remote digital media systems for receiving a contact list; the data indicative of contact details are received upon the first client providing access authentication for the respective digital media system, such that data indicative of contact details of one or more second prospective clients is received from the remote digital media systems.

20. A user access interface presented on a computing device for controlling a processor module, the processor module being coupleable to database adapted to retain a data record for each registered client; the interface comprising: a control program adapted to perform a method according to claim 1.
